(19) United States
(12) Patent Application Publication
(10) Pub. No.: US 2019/0340551 A1
(43) Pub. Date: Nov. 7, 2019

(54) SIGNAGE & ADVERTISING TRACKER & COMPLIANCE/REGULATION APPLICATION

(71) Applicant: Dirian Carmonte Moore, 51871 La Subida Dr, CA (US)

(72) Inventor: Dirian Carmonte Moore, 51871 La Subida Dr, CA (US)

(21) Appl. No.: 15/912,278

(22) Filed: May 3, 2018

(51) Int. Cl. G06Q 10/06; H04W 4/029

(52) U.S. Cl. CPC G06Q 10/06313; G06F 3/04847; H04W 4/029

(57) ABSTRACT

An Interactive application electronic communication device that helps user stay knowledgeable of the latest rules and regulations on signage and advertising for multiple industries targeting specific signage and ordinances. The electronic communication device application helps business owners, marketers and other professionals to plan, market, and be fully informed of and in compliance with local marketing/signage laws and ordinances throughout various cities, counties and states.

The application keeps track of physical signage & advertisements locations and provides consumers with the latest rules and regulations of signage usage based on their industry and GPS location and local government ordinances. The application provides notifications of expirations for all temporary installed signage currently deployed to be within compliance of local laws. The application has the capability to create signage and also gives the ability to order signs to be placed by the user or a third party or Sign sharing. The system is linked with a unique profile on the server, creates an embed HTML code widget to be utilized on any website in support of HTML embed code, to display signage routes that are setup and tracked within the electronic device application.

### BACKGROUND

While sitting at an open house I was completely beside myself on why it has been three hours since my last prospect came into the door. The house was priced below market so there should have been plenty of interested buyers. It was unknown to me while I was sitting there, my signs directing traffic to the open house had been confiscated by the local city enforcement/compliance officer. As a new agent I was unaware that the sign ordinances were so specific to the point where agents would need a whole different set of signs just by being the next city over. Essentially, someone may need to purchase multiple sets of signs if they are working in more than one city. After having to check the city ordinance links to find Where my signs had gone, I finally found the address and went to pick them up. In addition to my signs, they had collected about 50 other signs just that weekend. Per protocol, if they were not picked up they were to be discarded within 48 hours of the time they were picked up from the location of advertising. This is a massive amount of financial resources agents are losing out on.

From this experience I learned the knowledge of the city ordinances are vital for anyone who needs to advertise locally. However, the process of finding the city ordinances was extremely confusing and time consuming. Going through city websites, the links were confusing and I needed a more efficient way to get all the information in one place.

I also wanted to help my fellow agents by creating a way to track their signs and create a sign-sharing concept. Agents will be able to go back and collect their signs easily once they are done. The sign sharing concept would allow other agents to share their signs if they were not in use. With this method, agents would not have to buy a whole new set of signs if someone else is willing to let them rent their signs for a specific time. Agents who have signs that are not in use are able to generate business for themselves through the sign sharing concept and help keep other agents or marketers stay in compliance with the city, county, and state regulations. Additionally, this benefits cities by redirecting their resources since they will not need to collect signs that are out of compliance.

Ordering and sign sharing gives consumers the ability to order signage/advertising that best fits their needs. This includes custom signs or generic signs that will comply with their cities ordinances and regulations. They will be able to see if there is a generic sign that will be acceptable in multiple cities. Also, Sign Sharing will give the customers the ability to use other customers signs and have them placed in designated locations of their choosing.

Being a Realtor® I need to be knowledgeable of the signage/marketing ordinances per community/city/county/state when placing advertising signage markers to direct traffic to my target sales location. Signage includes yard signs, bus stop advertising, billboards and other print or physical signage. All signage needs to be in compliance with regulations to avoid confiscation, fines, and/or to prevent violating the law and loss of license. These same principals are common in other industries such as Realtor® Open House Signage, Marijuana Advertising via Billboards, Bus Stops, yard, garage, and estate sales; anything targeting the public must be in compliance with local ordinances and laws.

### BRIEF SUMMARY OF INVENTION

This application will allow users to track the location and amount of signs they have displayed, have easy access to sign ordinances specific to their location, allow sign sharing between members, and order signs in compliance with local laws and regulations.

### DESCRIPTION OF THE INVENTION

A mobile app developed to provide a tool to track marketing signage and ensure local compliance of city ordinances where the signage is to be displayed. The app provides the users the ability to drop pins to identify a GPS position using longitude and latitude and submit to our servers to pull the local laws & ordinances to display to the end user. The app provides pick up alarms if signage is to be taken down before a specific date/time. The over all core of the app is the ability to plan, verify, deploy and track all marketing signage.

### BRIEF DESCRIPTION OF THE DRAWING

These and other features of the present invention will be more fully disclosed when taken in conjunction with the following Detailed Description of the Invention in which like numerals represent like elements and in which:

FIG. 1 Identifies the end user/client

FIG. 2 Utilizing an electronic device to access the application

FIG. 3 Identifies core application aspects and application user interface for interaction

FIG. 4 Utilizing electronic device to connect to internet network

FIG. 5 Presenting and acknowledging permission to utilize GPS coordinates

FIG. 6 Function within application saving the “PIN Location” with GPS Coordinates and sending said information to references server for all signage/advertising regulations on the coordinates sent.

FIG. 7 Server application that lives in the cloud storing all user provided information and data exchange to with all regulation/content content.

FIG. 8 Database storing all laws & ordinances by industry. This information enforces laws & ordinances when information is referenced

FIG. 9. Database storing client profile information.

FIG. 10. Optional ability to order/request for sales & marketing products/services

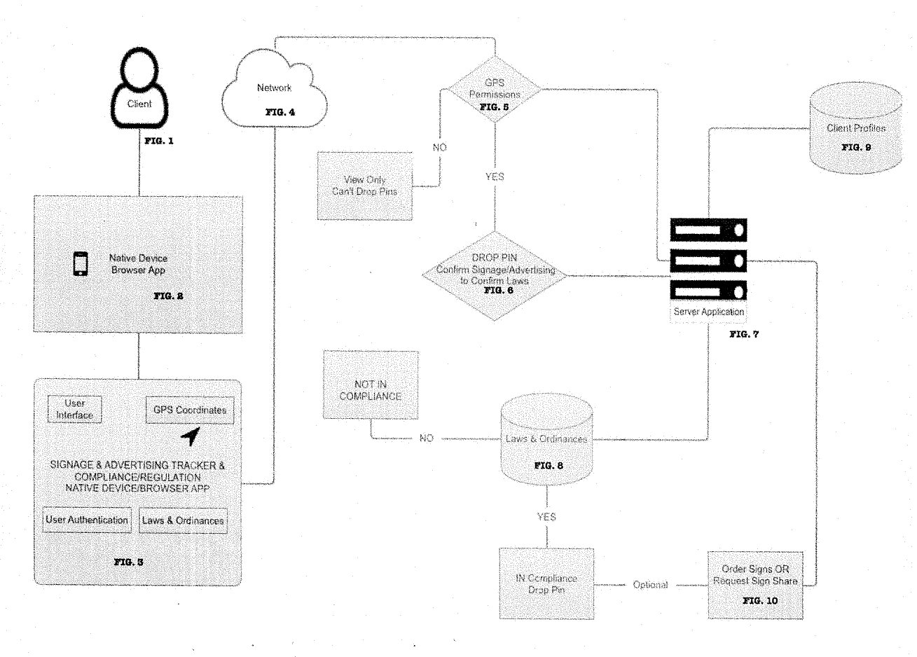

1. This is an interactive application while utilizing an electronic device. It will give the user the ability to drop multiple markers on the spot they would like to leave or have left signage and or advertising while keeping track of how many signs/advertising markers are left, along with a time period so that they are able to set reminders to remove signage/advertising.

2. The user has the ability to query for city/local ordinances based on their Global Positioning System (GPS) longitude and latitude location or inputted a specific address field like a physical address or zip code.

3. Application will give users ability to rent/purchase signage to be provided to them directly or placed on a route selected by users by the markers they drop in the App which is sent to another user/third party to be delivered.

4-9. (canceled)
